(19) United States
(12) Patent Application Publication
(10) Pub. No.: US 2004/0253966 A1
(43) Pub. Date: Dec. 16, 2004

(54) Networked service providers spontaneously respond and prepared to fulfill user's location-dependent requests

(76) Inventor: Bo-In Lin, Los Altos Hills, CA (US)

Correspondence Address: Bo-In Lin, 13445 Mandoli Drive, Los Altos Hills, CA, 94022, US

(21) Appl. No.: 10/865,189

(22) Filed: Jun. 10, 2004

Related U.S. Application Data
(60) Provisional application No. 60/477,490, filed on Jun. 10, 2003.

(51) Int. Cl. H04Q 7/20

(52) U.S. Cl. 455/456.5; 455/456.1

(57) ABSTRACT

A wireless network system includes a central electronic-commerce (e-commerce) server with an electronic-commerce (e-commerce) engine that has database for providing a directory of user-location dependent goods/service providers (ULDGSP) for a wireless network user to survey and select at least one ULDGSP. The e-commerce server further includes a master server to communicate with a selected ULDGSP having a store manager personal computer (PC) to establish a virtual direct communication with the wireless network user by using a redirection means for redirecting a data of ordering or inquiries received from the wireless network user to the store manager PC. The redirection means may also redirect the confirmation or delivery information data from the store manager PC back to the wireless network user with the same stream socket connection, to enable a real-time on-line communication between the wireless network user and the store manager PC.

This application claims priority to pending U.S. provisional patent application entitled NETWORKED SERVICE PROVIDERS SPONTANEOUSLY RESPOND AND PREPARED TO FULFILL USER'S LOCATION-DEPENDENT REQUESTS filed Jun. 10, 2003 by Bo-In Lin and accorded Ser. No. 60/477,490, the benefit of its filing date being hereby claimed under Title 35 of the United States Code.

### BACKGROUND OF THE INVENTION

1. Field of the Invention

This invention relates generally to wireless communication systems and electronic commerce. More particularly, this invention relates to a wireless communication system with infrastructure frameworks set up to enable the real-time location-dependent network communications for a good/service provider to prepare for a ready response to fulfill a spontaneous location-dependent request.

2. Description of the Prior Art

Even though the use of Internet and electronic commerce through different networks including the wireless communication systems are readily available, there are still limitations that such systems are not effectively used to spontaneously satisfy a real time needs, particularly when a wireless network user is traveling. A major difficulty is the unpredictability of the time and locations a user may have a sudden need of services of goods. Because the user is in transition from one location to another and the fulfillment for such a need is under most circumstances location-dependent. While the user may have an Internet connection through a wireless personal digital assistance (PDA) or other types of wireless communication device to find out a place of fulfillment by taking advantage of the capability of identifying a user location by the global position system (GPS). However, because of the unpredictability of the location and time, it is often very difficult to establish real-time spontaneous communication between the users and the providers of the goods and service in proximity to the user. While the user may actively search to find out a location-dependent provider nearby to obtain the needed goods or services, however, as a direct communication with particular good or service providers is often difficult to establish, under most circumstances, the providers of the goods or services are not aware of the upcoming request from a wireless user and would remain totally idle and can only passively waiting for next customer. This lack of spontaneous communication between the users and the providers of goods and service often hinder the timeliness and effectiveness of the fulfillment processes.

There are at least two kinds of difficulties a user often encounters in the attempt to establish a network communication with a user location-dependent provider of goods and service. The first difficulty comes from the reality that many of smaller providers of goods and service in the local area, near the wireless network user who is in need to contact a local good/service provider, do not have appropriate network communication hardware and software capabilities for direct network communication with a wireless network user. A wireless network user's options for requesting goods/service are therefore limited. Choices are limited to providers operated by larger corporations that have network communication capabilities, small independent shops that do not have their own website on the Internet are not available.

But even for large corporations that have conveniently searchable websites, the smaller or remote operation units such as warehouses or shipping departments, even as part of a big cooperation, are still not able to enjoy the full benefits of direct real-time on-line communications directly with a requester to conduct real time communications for transactions. Therefore, a large number of business entities are not able to take full advantage of direct Internet communications to realize the benefits of electronic commerce. The difficulty arises from the fact that smaller or remote operation units do not have sufficient hardware, software or engineering resources to function as a Web site server to communicate directly with an on-line customer by sending Web pages and receiving the data of ordering or inquiries. To setup and maintain Web sites require specific technical expertise. Smaller or remote operational units of a big cooperation or individual store or shops generally lack such technical resources. External contractors can be employed to setup and maintain the Web sites, but the cost and efforts involved often are not immediately rewarding. For these reasons, smaller stores or operational units, e.g., an off-site warehouse or a repair shop, and a large number of business units ranging from a mid-to-small size corporations to corner drug stores still face the difficulties of knowing that direct communication is desirable and necessary but also unable to set up such communication systems due to a cost effective method to develop such capabilities are not readily available.

A second difficulty is caused by the unavailability of the local information when a driver is passing through an unfamiliar town with totally no concept of who and where are the goods or service providers available for on-line communications. It becomes very difficult to conduct an electronic commerce and such that the needed goods or services can be ready in response to a spontaneous request. Conventional technology of electronic commerce even with advancements of wireless and Internet development, a wireless often finds that the wireless network still does not have the features to allow for searching and establish spontaneous communications with a local goods and services providers such that the goods or service request can be fulfilled in next ten minutes to half-an-hour.

Therefore, there is still a need in the art of electronic commerce through Internet to overcome these technical difficulties and limitations.

### SUMMARY OF THE PRESENT INVENTION

It is therefore an object of the present invention to provide a network communication configuration to enable a wireless network user to instantaneously find and communicate with a user-location-dependent goods-or-service provider (ULDGSP) such that an ULDGSP can start the preparations to fulfill a goods-or-service request (GSR) from the wireless network user upon the arrival of the wireless network user at the store of the user-location-dependent GSP.

It is another object of the present invention to provide new and improved system configuration and network communication methods to facilitate direct real-time on-line communication between customer and a direct resource that is able to fulfill the request transmitted through network communication. An Internet resource request-response interaction center is established to facilitate real time interaction between a wireless goods-or-service requester and a resource, e.g., a direct goods-or-service provider (GSP), to eliminate the problem caused by indirect message and information transmissions.

Specifically, it is an object of the present invention to provide a wireless Internet request-response interaction center for providing user-location-dependent database available for a wireless network user for spontaneous viewing and selecting a ULDGSP and also facilitate direct interaction between a the wireless network user and the ULDGSP. A wireless network user can have instantaneous communications with a ULDGSP for sending requests and receiving responses to get ready for fulfillment of goods-services requests upon the wireless network user's arrival at the location of the ULDGSP. By applying a stream-socket technology offered in Java for connecting processes, a “virtual-direct” communication between the wireless network user and the ULDGSP can be established. The virtual direct communication between a requester and the respondent enables a person of ordinary skill in the art to resolve the difficulties arising from indirect communications as that often occurred in the conventional network configurations.

Briefly, in a preferred embodiment, the present invention discloses a wireless network system. The wireless network system includes a central electronic-commerce (e-commerce) server with an electronic-commerce (e-commerce) engine that has database for providing a directory of user-location dependent goods/service providers (ULDGSP) for a wireless network user to survey and select at least one ULDGSP. The e-commerce server further includes a master server to communicate with a selected ULDGSP having a store manager personal computer (PC) to establish a virtual direct communication with the wireless network user by using a redirection means for redirecting a data of ordering or inquiries received from the wireless network user to the store manager PC. The redirection means may also redirect the confirmation or delivery information data from the store manager PC back to the wireless network user with the same stream socket connection, to enable a real-time on-line communication between the wireless network user and the store manager PC. In a preferred embodiment, the e-commerce engine further has a Web page processor for providing Web pages to the wireless network user. In another preferred embodiment, the e-commerce engine further has a database for storing good-or-service catalog of the store manager PC for allowing the wireless network user to order the good-or-service from the store manager PC.

In another preferred embodiment, the e-commerce engine further has a shopping cart for temporary holding the merchandise items and/or item Ids selected by customers. In another preferred embodiment, the e-commerce engine further has a store manager PC registration-and log-in/log-out processor for registering and logging in and out the store manager PC. The log-in/log-out process enables the central e-commerce server to obtain store manager PC's IP address and flexibility for stores to use dynamic IP address. In another preferred embodiment, the e-commerce engine further has a capability of handling multiple orders from different client customers at same time and redirecting the transaction data to different store manager PC according to customer's request. Such an Internet system is efficient and economical because many different stores can share a same central e-commerce server with the e-commerce engine described hereby.

In summary this invention discloses a method for instantaneously providing a user location dependent directory listing a plurality of user-location-dependent goods/service providers (ULDGSP) to a wireless network user using a networked requesting data handling system. The method further includes a step of receiving an electronic-commerce requesting message from the wireless network user and generating a virtual-direct interaction by redirecting the electronic commerce requesting message in real time to a computer of a user selected ULDGSP functioning as a networked responding data handling system. In a preferred embodiment, the method further includes a step of receiving and redirecting a response for responding to the electronic commerce requesting message from the respondent data handling system to the wireless network user sending the electron message from the requesting data handling system for providing the virtual-direct interaction between the requesting data handling system and the respondent data handling system.

In essence, a network system for generating a virtual-direct interaction between a wireless net-requester for a good-or-service and a direct-resource for providing the good-or-service is disclosed in this invention. The network system includes a process instantiating means for instantiating a receiving process and a transmitting process for receiving and transmitting requests and a responses. The network system further includes a communication socket means for channeling each of responses to a corresponding request. The communication socket means enables a net-requester for good-and-service and the direct-resource for providing the good-or-service to have a virtual-direct interaction for conducting a real-time interactive communication on the network system. Such network system can handle multiple requests and redirect the requests to different store manager PCs with the multiple thread technology of JAVA.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIG. 1 is a functional block diagram for showing a wireless communication system for a wireless network user to directly communicate with a ULDGSP;

FIG. 2 is a flowchart for showing the steps carried out by a wireless network communication system of this invention to enable a wireless network user to spontaneously order and receive timely fulfillment at a ULDGSP;

FIG. 3 is network communication system interconnecting an electronic commerce engine interacting between a net-customer and an on-line store to generate virtual-direct interactions for conducting e-commerce transactions;

FIG. 4 is an architecture structure of the links between a home pages and Web pages for carrying out different functions performed by the electronic commerce engine of FIG. 1; and

FIG. 5 shows the architecture of a network system where an electronic commerce engine is connected to and applied to redirect requests and responses between multiple clients and resource providers for generating multiple virtual-direct network interactions.

### DETAILED DESCRIPTION OF THE PREFERRED EMBODIMENT

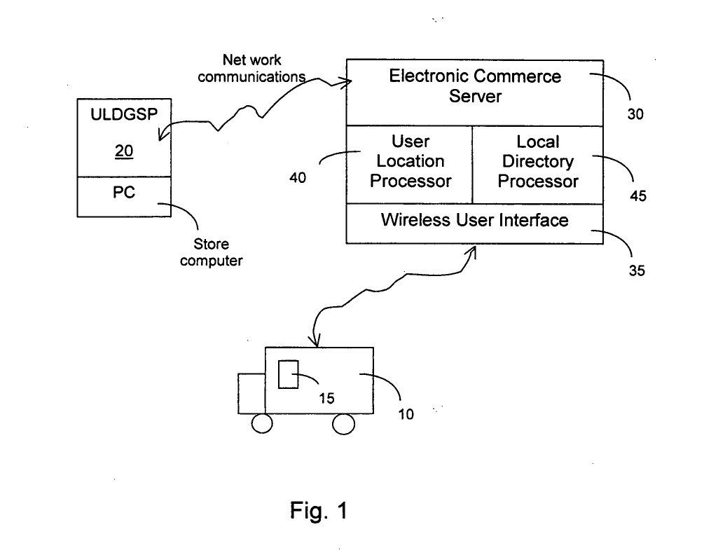

FIG. 1 is a functional block diagram showing a mobile network communication system disclosed in this invention to enable a two-way real-time instantaneous communication between a mobile network user and a user-location dependent goods or service provider (ULDGSP). The mobile network user is traveling in a vehicle 10 through a town where an ULDGSP 20 is located. The ULDGSP 20 may be an automobile repair shop, a drug store, a restaurant, a hotel, a hospital or any local store that can fulfill a good-service request sent out by the mobile network user upon the arrival of the wireless network user. The wireless network user 10 sends out a good-service request (GSR) to an electronic commerce server 30. The electronic commerce server 30 includes a wireless user interface 35 to receive and process the request sent out by the wireless network user 10. The electronic commerce server 30 further includes a user-location processor 40 to determine the location of the wireless network user 10 using the geographic location information contained in the GSR sent by the wireless network user 10. After the electronic commerce server 30 determines the location of the wireless network user 10, a local directory stored or acquired by a local d Timesavings are achieved as the wireless network user is traveling to the ULDGSP 20; the orders are prepared and get ready for fulfillment upon the arrival of the wireless network user 10.

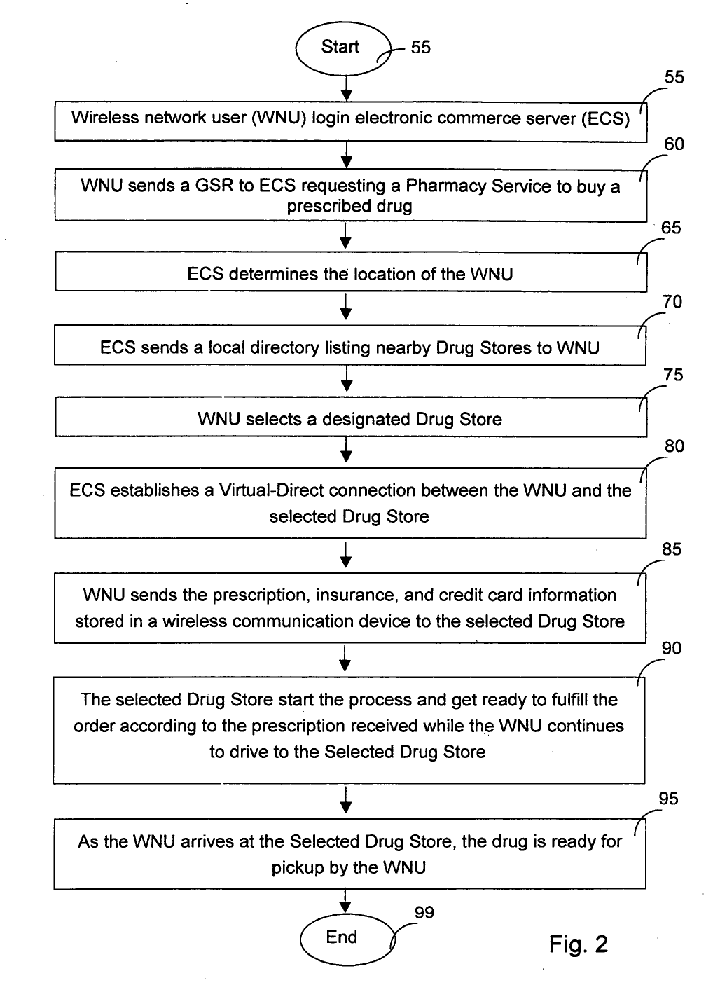

FIG. 2 is a flowchart for showing an example of the processing steps that a local hospital using a personal computer as a networked user location dependent goods-service provider (ULDGSP) is enabled to spontaneously respond to a wireless network user to prepare and get ready to treat the wireless network user upon the arrival of the wireless network user. The process starts when a wireless network user (WNU) 10 drives through a town on a out of state trip and suddenly finds out that a prescribed drug is not brought along and she needs a refill immediately (Step 50). The WNU logs on to an electronic commerce server (ECS) 30 of this invention (step 55) and sends out a good-service request (GSR) to the ECS 30 to request a prescribed drug service from a user location dependent drug store as a user location dependent good and service provider (ULDGSP) 20 (Step 60). The GSR sent by the WNU also provides geographic location for the ECS to determine the location of the WNU that sends out the GSR (Step 65). The ECS then sends out a local directory that lists nearby drug stores to the WNU (step 70) for the WNU to select a designated drug store (Step 75). The ECS then establish a virtual direct communication channel between the WNU and the selected drug store (Step 80) by applying a special technique as further described below. The WNU then sends out the prescription, insurance and credit card information as stored in a wireless communication device as required to the selected drug store as the ULDGSP (Step 85). The selected drug store receives the information sent by the WNU and starts to process the prescribed order and get ready to fulfill the order according to the prescription information while the WNU continues to drive to toward the selected drug store (Step 90). When the WNU arrives at the selected drug store after driving a certain distance, the prescription order is prepared and ready to the WNU to pickup and continue the trip (Step 95), then the processes end (step 99). The ECS of this invention thus performs two major functions by first determining the geological location of the WNU and then establishing a “virtual connection” between the WNU and a selected ULDGSP.

From the perspective of a wireless network user (WNU), a wireless communication device, e.g., a PDA-cell-phone or a wireless-PDA-GPS, may provide special button or key arrangement to enhance the operation of this invention for sending out the user-location-dependent goods-service requests. For instance, special key arrangement may be used to provide a special key for user to dial in and logon to the ECS by simply pushing a key. Further arrangements of the keys may be made to prearrange the key on a phone such that “H”, i.e., keypad number (4), is for sending out a request for Hospital, “M”, i.e., keypad number (6), is for sending out a request for Motel or Hotel. A key “R”, i.e., keypad number (77), is for sending out a request for Restaurant, “S”, i.e., keypad number (777), is for sending out a request for General Shopping and “G”, i.e., keypad number (4), is for sending out a request for Grocery Shopping. It is further desirable that different kinds of data files are stored in the wireless communication device, e.g., prescriptions for pharmacist, medical records for checking in hospitals, shopping lists for checking if a shopping mall has the selected items, favorite dish selections for order dishes to go, car maintenance records for fixing a car problem by a mechanical shop, etc. The data files may be sent out to the ULDGSP upon communication is established to speed up the preparation processes. Special encoded credit card information may be setup and stored in a wireless communication device. The encoded credit card information or payment charge account data may be sent out as a file to speed up the communication processes between a WNU and a selected LDGSP such that the selected LDGSP can quickly process a request received from a WNU to prepare and get ready to fulfill the order up the arrival of the WNU at the LDGSP.

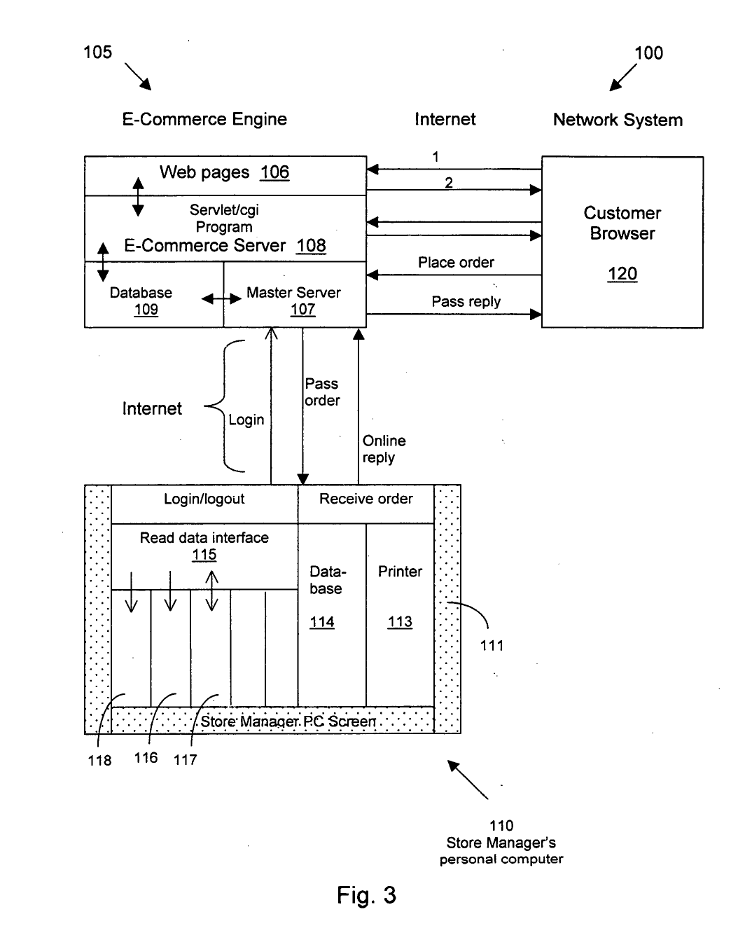

FIG. 3 is a functional block diagram of a network system 100, e.g., an Internet network system, for carrying out electronic commerce thereon. The network system 100 comprises an electronic-commerce server, e.g., an e-commerce engine 105, networked through Internet or Intranet with a store-manager personal computer 110. The e-commerce engine 105 is also networked with a customer who interfaces with the electronic e-commerce engine 105 through a consumer browser 120 that could be a typical Internet browser such as a Microsoft Explorer or Netscape or some other browser. The customer communicates via the consumer browser 120 sending electronic commerce messages to the e-commerce engine 105 through the Internet for ordering services or goods from the store manager 110. The e-commerce engine 105 interfaces with the customer browser 120 through Web pages 106 executed and controlled by a central e-commerce server 107 running servlet/cgi programs 108 getting data from the database 109. The Web pages, which the e-commerce engine 106 sends to the customer browser 120, include catalogs of goods or services provided by the store 110. The catalogs are stored in the database 109. In reviewing the store catalog, a customer can select items of good or service to temporarily store in the shopping cart provided by the e-commerce engine 105. The customer can then review and verify the selected items and the price listed for each item generated by the shopping cart program for display on the web pages. After verifying the ordering information, the net customer then submits the order for transmitting to the master server 107 of the e-commerce engine 105 through stream socket connection.

Once the e-commerce engine 105 receives a request for ordering goods or services from the store 110 via a stream of data transmitted from the Internet, the e-commerce engine 105 instantiates an incoming order process. As soon as an incoming order process is instantiated, another process is also instantiated for transmitting the order to the store manager 110. The master server 107 also employs a stream-socket technology to establish a second connection for connecting the order transmission process and the incoming order reception process in the store manager PC 110 while the first stream socket connection is still active. A “seamless” communication is therefore established between the customer browser 120 and the store manager 110.

The store manager 110 is typically built on a personal computer (PC) that is provided with a monitor 111 for graphic display and a printer to print out the hard copies of the ordering. The PC 110 is connected to the Internet through an Internet interface module 112 that is provided with order receiving/response means 112-1 and log-in/log-out processor 112-2 to log in and out from the e-commerce engine 105. The orders received through the order receiving/response means 112-1 and transmitted from the Internet are printed on a printer 113 and stored in a database 114. Meanwhile the data transmitted through the order receiving/response means 112-1 is transmitted through a data bus 115 for the PC to process different functions related to the incoming order. Such process may include a search of the database 116 for updating the status of the order 117, for generating order priority 118, and for performing other kinds of store keeping functions such as inventory control, account receivable, etc. A response is also generated from the store manager PC 110 and transmitted to the e-commerce engine 105 through the second stream socket connection established before.

As the master server 107 of e-commerce engine 105 receives the response to the order sent from the store manager PC 110, a response-reception process is generated. Meanwhile, upon receiving the response to order, a response transmission process is generated for sending the response to order to the customer 120 who requests the order through the first stream socket connection as that generated before. Once such two connections are established, a “virtual direct” communication is formed between the responding store manage PC 110 and the requesting customer 120 for exchange information relevant to the order of the services and goods from the store 110.

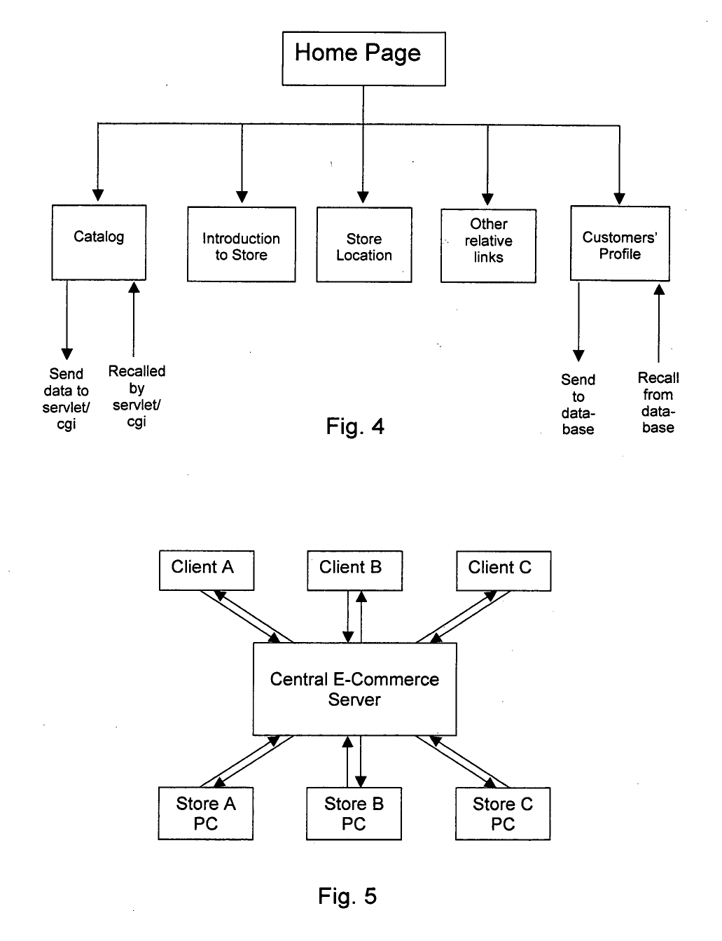

FIG. 4 is an architecture framework of the home page of the e-commerce engine 105. The home page has a link to the introduction to the store and another Web page for showing the store location. For each store, there is a catalog available for an Internet customer to review and make order. Other kinds of links relevant to the e-commerce interactions are also available. Then, for customer to make order goods or services, a customer profile Web page is provided for the customer to enter customer's names and other profile data. A stored customer profile in the database can be retrieved to expedite the ordering process without requiring an old customer to re-enter the same data again.

FIG. 5 is an functional block diagram showing the architectural configuration of the interconnections between multiple of net-clients, e.g., clients A, B, and C, logged onto the central e-commerce server. Each of these clients are then carrying out a “virtual-direct” interaction to perform on-line commercial transactions simultaneously with stores, e. g. store A, B, and C personal computers. A JAVA multiple-thread technology allows the central e-commerce server to perform these multiple transactions by redirecting multiple processes as shown in FIG. 5.

In essence, this invention discloses a method for receiving and responding an electronic commerce message between networked data handling systems. The method includes a step of receiving an electronic-commerce requesting message from a requesting data handling system and generating a virtual-direct interaction by redirecting the electronic commerce requesting message in real time to a networked responding data handling system. In a preferred embodiment, the method further comprises a step of receiving and redirecting a response for responding to the electronic commerce-requesting message from the respondent data handling system to the requesting data handling system. This step is to provide the virtual-direct interaction between the requesting data handling system and the respondent data handling system.

In summary, this invention further discloses a network system for generating a virtual-direct interaction between a net-requester for a good-or-service and a direct-resource for providing the good-or-service. The system includes a process instantiating means for instantiating a receiving process and a transmitting process for receiving and transmitting requests and responses. The network system further includes a communication socket means for channeling each of responses to a corresponding request. The communication socket means enables a net-requester for good-and-service and the direct-resource for providing the good-or-service to have a virtual-direct interaction for conducting a real-time interactive communication on the network system. In a preferred embodiment, the process connection means comprising a stream socket connection means for generating steam socket for connecting the transmission process with the receiving process. Such network system can handle multiple requests and redirect the requests to different store manager PCs with the multiple thread technology of JAVA.

The Internet system described above is functionally capable to handle multiple ordering requests and to redirect to different stores with one same e-commerce server with the e-commerce engine described above. Furthermore, the present invention can be employed for all types of applications carried out with the network system described above and the e-commerce/service center which provide network e-commerce services for different types of small business operations. Restaurant, pizza store, bookstore, gift shop, drugstore, grocery store, furniture store, video/movies store and any other stores selling merchandise, with national or local franchise can use a system as disclosed in this invention. The system and configurations disclosed in this invention can also be applied to services requested and reservation made with doctor office, or business appointment, hotel/motel reservation, merchandise warehouse/manufacture site/stockroom, international and/or domestic trading business.

In essence, this invention discloses a network communication system provided for allowing a wired or a wireless network user to identify and establish a communication with a location dependent good-or-service provider (LDGSP) via a user location-dependent-request processing server. The user location-dependent-request processing sever receives and responds to a user location-dependent-request sent by a user from a user location for initiating a preparation for a fulfillment-in-person of the user location-dependent-request in anticipation of the user to arrive at a request-fulfillment location.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

I claim:

1. A network communication system for enabling a network user to spontaneously establish a two-way real-time communication with a location-dependent goods-or-service provider (LDGSP) comprising:
an electronic commerce server for receiving a location dependent goods-or-service request (LDGSR) from said network;
said electronic server includes a network user location processor for processing said LDGSR for determining a location of said network user;
said electronic server further includes a location dependent goods-or-service provider database for providing to said network user a list of location dependent goods-or-service providers (LDGSP) in response to said LDGSR for said network user to select a designated LDGSP from said list of LDGSP; and
said electronic commerce server further includes a virtual direct communication processor for establishing a virtual-direct communication between said network user and said designated LDGSP.

2. The network communication system of claim 1 wherein:
said electronic commerce server further includes a stream-socket processing program for instantiating multiple communication connections for establishing said virtual direct communication between said network user and said designated LDGSP.

3. The network communication system of claim 1 wherein:
said network user is a wireless network user having a wireless communicating device for sending said LDGSR to said electronic commerce.

4. The network communication system of claim 1 wherein:
said LDGSR further comprising a network user location data for said electronic commerce to determine a location of said network user.

5. The network communication system of claim 1 wherein:
said LDGSR further comprising a network user's global position system (GPS) data for said electronic commerce to determine a location of said network user.

6. The network communication system of claim 1 wherein:
said network user is a mobile network user having a mobile wireless communicating device for sending said LDGSR to said electronic commerce.

7. The network communication system of claim 1 wherein:
said LDGSR further comprising a request for a location-dependent hospital service.

8. The network communication system of claim 1 wherein:
said LDGSR further comprising a request for a location-dependent automobile repair service.

9. The network communication system of claim 1 wherein:
said LDGSR further comprising a request for a location-dependent prescription drug service.

10. The network communication system of claim 1 wherein:
said LDGSR further comprising a request for a location-dependent grocery store.

11. The network communication system of claim 1 wherein:
said LDGSR further comprising a request for a location-dependent restaurant.

12. The network communication system of claim 1 wherein:
said network user is a cellular phone user having a cellular phone for sending said LDGSR to said electronic commerce.

13. The network communication system of claim 1 wherein:
said network user is a personal assistant device (PDA) user having a PDA for sending said LDGSR to said electronic commerce server.

14. The network communication system of claim 1 wherein:
said designated LDGSP further comprising a personal computer (PC) for communicating with said electronic commerce server via an Internet system.

15. The network communication system of claim 1 wherein:
said network user is wireless device user for operating a wireless device wherein said wireless device storing a set of pre-defined good-or-service relevant data for sending to said designated LDGSP via said electronic commerce server.

16. The network communication system of claim 1 wherein:
said network user is wireless device user for operating a wireless device wherein said wireless device storing a set of personal medical data for sending to a local hospital as said designated LDGSP via said electronic commerce server.

17. The network communication system of claim 1 wherein:
said network user is wireless device user for operating a wireless device wherein said wireless device storing a set of automobile maintenance record data for sending to a local automobile repair shop as said designated LDGSP via said electronic commerce server.

18. The network communication system of claim 1 wherein:
said network user is wireless device user for operating a wireless device wherein said wireless device storing a set of grocery shopping list data for sending to a local grocery store as said designated LDGSP via said electronic commerce server.

19. The network communication system of claim 1 wherein:
said network user is wireless device user for operating a wireless device wherein said wireless device storing a set of drug prescription data for sending to a local drug store as said designated LDGSP via said electronic commerce server.

20. A method for enabling a network user to spontaneously establish a two-way real-time communication with a location-dependent goods-or-service provider (LDGSP) comprising:
said network sending a location dependent goods-or-service request (LDGSR) to an electronic commerce server;
said electronic server processing said LDGSR for determining a location of said network user for providing to said network user a list of location dependent goods-or-service providers (LDGSP) in response to said LDGSR;
said network user selecting a designated LDGSP from said list of LDGSP for said electronic commerce server to establish a direct communication between said network user and said designated LDGSP.
receiving and responding to a user location-dependent-request sent by a user for initiating a preparation for a fulfillment-in-person of said user location-dependent-request in anticipation of said user to arrive at a request-fulfillment location.

21. A network communication system comprising:
a user location-dependent-request processing server for receiving and responding to a user location-dependent-request sent by a user from a user location for initiating a preparation for a fulfillment-in-person of said user location-dependent-request in anticipation of said user to arrive at a request-fulfillment location.

22. The network communication system of claim 21 wherein:
said server for receiving said user location dependent request further comprising a processor for receiving and processing a said user location dependent request from a wireless network user.

23. The network communication system of claim 21 wherein:
said network user further having a wireless device provided for receiving a voice command from said network user for sending said user location dependent request to said location-dependent-request processing server.
